(19) United States
(12) Patent Application Publication
(10) Pub. No.: US 2021/0385554 A1
(43) Pub. Date: Dec. 9, 2021

(54) INFORMATION PROCESSING DEVICE, INFORMATION PROCESSING METHOD, AND INFORMATION PROCESSING PROGRAM

(71) Applicant: SONY GROUP CORPORATION, Tokyo (JP)

(72) Inventors: Kei TAKAHASHI, Tokyo (JP); Tsuyoshi ISHIKAWA, Kanagawa (JP); Ryouhei YASUDA, Tokyo (JP)

(73) Assignee: SONY GROUP CORPORATION, Tokyo (JP)

(21) Appl. No.: 17/284,275

(22) PCT Filed: Sep. 12, 2019
(86) PCT No.: PCT/JP2019/035805

§ 371 Date: Apr. 9, 2021

(30) Foreign Application Priority Data
Oct. 16, 2018 (JP) 2018-195452

(51) Int. Cl. H04N 21/81; H04N 21/4788; H04N 21/414

(52) U.S. Cl. CPC H04N 21/8133; H04N 21/41407; H04N 21/816; H04N 21/4788

(57) ABSTRACT

An information processing device (100) includes an acquisition unit (131) that acquires related information related to video, a specification unit (134a) that, on the basis of the related information acquired by the acquisition unit (131) and video corresponding to a first viewpoint, specifies a second viewpoint different from the first viewpoint, and a display unit (134) that, together with video corresponding to the second viewpoint specified by the specification unit (134a), causes the related information acquired by the acquisition unit (131) to be displayed.

### TECHNICAL FIELD

The present disclosure relates to an information processing device, an information processing method, and an information processing program.

### BACKGROUND ART

There is a conventional technology that, in a case where accepting a comment regarding an object in a moving image from a plurality of users, causes the input comment to be displayed so as to follow the object.

### CITATION LIST

### Patent Document

Patent Document 1: Japanese Patent Application Laid-Open No. 2014-225808

### SUMMARY OF THE INVENTION

### Problems to be Solved by the Invention

However, in the conventional technology described above, there is a problem that an area for displaying a comment overlaps an area for an object in a moving image.

If the area of the object in the moving image and the area for displaying the comment overlap, the comment hides the object. Therefore, in a case where accepting an input of the comment regarding the object in the moving image, it is a problem to display the area of the object and the area for displaying the comment so as not to overlap.

Therefore, the present disclosure, in a case where accepting the input of the comment regarding the object in the moving image, proposes an information processing device, an information processing method, and an information processing program capable of displaying the area of the object and the area for displaying the comment so as not to overlap.

### Solutions to Problems

In order to solve the problem described above, the information processing device of one form according to the present disclosure includes an acquisition unit that acquires related information related to video, a specification unit that, on the basis of the related information acquired by the acquisition unit and video corresponding to a first viewpoint, specifies a second viewpoint different from the first viewpoint, and a display unit that, together with video corresponding to the second viewpoint specified by the specification unit, causes the related information acquired by the acquisition unit to be displayed.

### BRIEF DESCRIPTION OF DRAWINGS

FIG. 1 is a diagram illustrating an example of an information processing system according to the first embodiment.

FIG. 2 is a diagram illustrating an example of processing related to a comment posting.

FIG. 3 is a diagram illustrating an example of a confirmation screen of a comment.

FIG. 4 is a diagram illustrating an example of a functional configuration of a head-mounted display (HMD) according to the first embodiment.

FIG. 5 is a diagram illustrating an example of a functional configuration of a distribution server according to the first embodiment.

FIG. 6 is a diagram illustrating an example of a data structure of a content DB.

FIG. 7 is a diagram illustrating an example of a functional configuration of a comment management server according to the first embodiment.

FIG. 8 is a diagram illustrating an example of a data structure of the comment DB.

FIG. 9 is a diagram illustrating an example of a functional configuration of an information processing device according to the first embodiment.

FIG. 10 is a diagram illustrating an example of free viewpoint video information in which a comment is arranged.

FIG. 11 is Diagram (1) for explaining a process in which a specification unit changes viewpoint information.

FIG. 12 is a diagram illustrating an example of a change in an angle of view as a viewpoint moves.

FIG. 13 is Diagram (2) for explaining a process in which a specification unit changes the viewpoint information.

FIG. 14 is Diagram (3) for explaining a process in which a specification unit changes the viewpoint information.

FIG. 15 is Diagram (4) for explaining a process in which a specification unit changes the viewpoint information.

FIG. 16 is Diagram (5) for explaining a process in which a specification unit changes the viewpoint information.

FIG. 17 illustrates Flowchart (1) illustrating a processing procedure of the information processing device according to the first embodiment.

FIG. 18 illustrates Flowchart (2) illustrating a processing procedure of the information processing device according to the first embodiment.

FIG. 19 is Diagram (1) illustrating an example of a display screen according to a modification example of the first embodiment.

FIG. 20 is Diagram (2) illustrating an example of a display screen according to a modification example of the first embodiment.

FIG. 21 is a diagram illustrating an example of an information processing system according to the second embodiment.

FIG. 22 is a hardware configuration diagram illustrating an example of a computer that realizes a function of the information processing device.

### MODE FOR CARRYING OUT THE INVENTION

Hereinafter, embodiments of the present disclosure will be described in detail on the basis of the drawings. Note that, in each of the following embodiments, duplicate description will be omitted by assigning the same signs to the same portions.

### 1. First Embodiment

### [1-1. Configuration of System According to the First Embodiment]

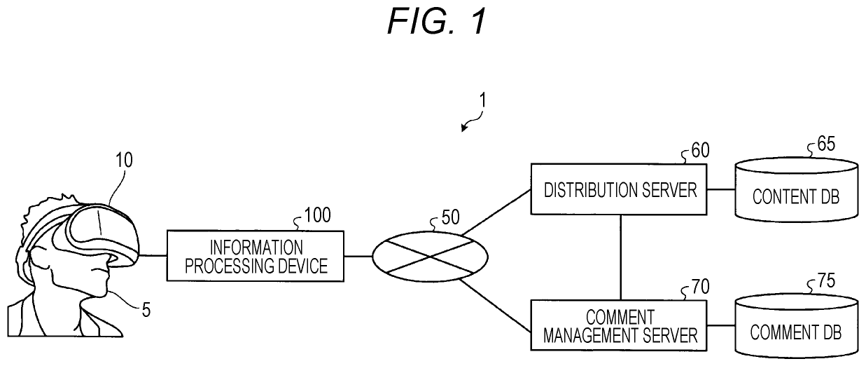

FIG. 1 is a diagram illustrating an example of an information processing system according to the first embodiment. As illustrated in FIG. 1, the information processing system 1 includes an HMD 10, a distribution server 60, a comment management server 70, and an information processing device 100. For example, the HMD 10 is connected to the information processing device 100 via a wired line or wirelessly. The information processing device 100 is connected to the distribution server 60 and the comment management server 70 via a network 50. Also, the distribution server 60 and the comment management server 70 are connected to each other.

Although not illustrated in FIG. 1, the information processing system 1 may include another HMD and another information processing device.

The HMD 10 is a display device worn on the head of a user 5 and is a so-called wearable computer. The HMD 10 displays a free viewpoint video based on a position of a viewpoint designated by the user 5 or the position of the viewpoint automatically set. The user 5 can post a comment and browse a comment posted by another user while viewing the free viewpoint video. In the following description, a case where the HMD 10 displays a virtual reality (VR) free viewpoint video on the display will be described.

For example, in a case where an input device such as a keyboard and the like is connected to the HMD 10, the user 5 operates the input device to post a comment. In a case where a microphone and the like are connected to the HMD 10 and voice input is possible, the user 5 may post a comment by voice. Also, the user 5 may post a comment by operating a remote controller and the like.

In the first embodiment of the present disclosure, the description will be made on an assumption that the user 5 watches the, content of each sport. The user 5 can post a comment and share the posted comment with other users while watching the content. The information regarding the comment posted by the user 5 is transmitted to the comment management server 70 and reported to other users. Also, information regarding comments posted by other users is reported to user 5 via the comment management server 70. The comments posted by other users may also include those corresponding to comments posted by user 5.

The distribution server 60 is connected to a content DB 65. The distribution server 60 is a server that transmits information regarding a content stored in the content DB 65 to the information processing device 100. In the following description, information regarding the content is referred to as “content information” as appropriate.

The comment management server 70 is connected to a comment DB 75. The comment management server 70 receives information regarding comments by user 5 and other users and stores the received information regarding comments in the comment DB 75. Also, the comment management server 70 transmits the information regarding comments stored in the comment DB 75 to the information processing device 100. In the following description, information regarding comments is referred to as “comment information” as appropriate.

The information processing device 100 is a device that, when accepting a designation of a viewpoint position from the HMD 10, generates a free viewpoint video in a case where a virtual camera is installed at the accepted viewpoint position on the basis of the content information and causes the generated free viewpoint video to be displayed on the HMD 10. Also, in a case where the comment information is received from the comment management server 70, the information processing device 100 causes the comment to displayed cm the free viewpoint video. Since a target of the comment is set in the comment information, in a case where displaying the comment, the information processing device 100 causes the comment to be displayed in association with the target.

Here, in a case where causing the comment to be displayed on the free viewpoint video based on the designated viewpoint and the comment overlaps another object, the information processing device 100 changes the current viewpoint position so that the comment does not overlap the other object. The process of changing the viewpoint position by the information processing device 100 will be described later.

### [1-2. Example of Processing Related to Comment Posting]

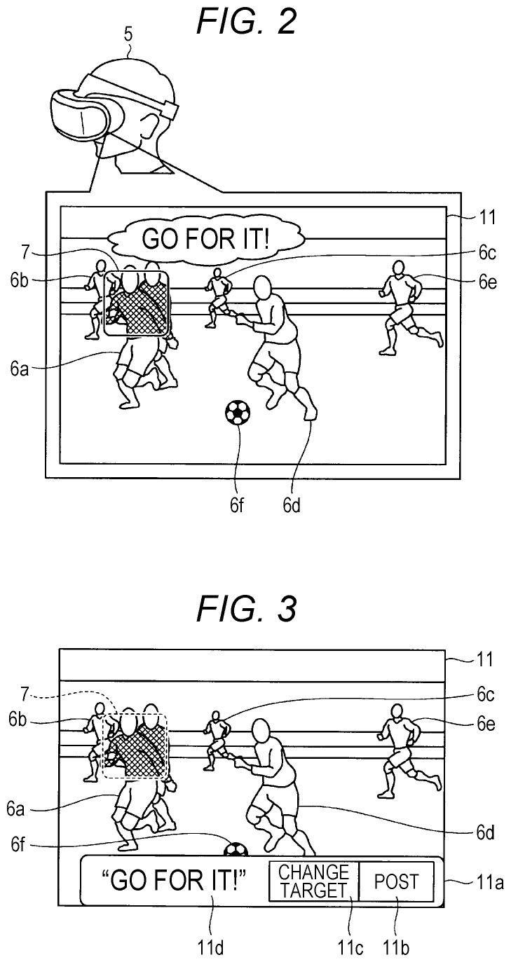

FIG. 2 is a diagram illustrating an example of processing related to a comment posting. The HMD 10 displays an object that collides with a line-of-sight direction of the user 5 immediately before the user 5 posts a comment. For example, in a case where a part of the object is included in a certain range ahead in the line-of-sight direction of the user 5, the HMD 10 displays such an object as a colliding object. In the example illustrated in FIG. 2, the HMD 10 detects the object 6a that collides with the line-of-sight direction of the user 5 by comparing the line-of-sight direction of the user 5 with positions each of the objects 6a to 6f and displays a frame 7 indicating that the object 6a becomes the target on the display 11. The user 5 can confirm whether or not the object intended by the user 5 is the target by the frame 7. Note that the HMD 10 may detect an object that collides with the direction of the head of the user 5 based on the direction of the head of the user 5 instead of the direction of the line-of-sight of the user 5.

After the target is detected, the user 5 inputs (posts) a comment by voice, a keyboard, or the like. In the example illustrated in FIG. 2, the comment “Go for it!” is input by the user 5. When the HMD 10 accepts the input of the comment, the HMD 10 and the information processing device 100 cooperate to generate the comment information. The comment information is associated with the time when the comment was posted, viewpoint information, identification information of the target, identification information of the user 5, and the content of the comment. The viewpoint information includes the position and direction of the virtual camera of the content (free viewpoint video).

In a case where accepting the input of the comment from the user 5, the HMD 10 may confirm the input comment. FIG. 3 is a diagram illustrating an example of a confirmation screen of a comment. In the example illustrated in FIG. 3, a confirmation screen 11a is displayed on the display 11. The user 5 refers to the confirmation screen 11a and, in a case where the content and target of the comment are appropriate, operates the keyboard and the like to press a button for “Post” 11b.

On the other hand, in a case where the target is not appropriate, the user 5 presses a button for a target change 11c. The HMD 10 moves the position of the frame 7 to any of objects 6a to 6f each time the button 11c is pressed. The user 5 presses the button for “Post” 11b in a case where the frame 7 is arranged on the appropriate object. Also, in a case where the content of the comment is not appropriate, the user 5 may select a comment field lid on the confirmation screen 11a and re-enter the comment. In the following description, in a case where not being specified to the user 5, it is simply referred to as a user.

### [1-3. Functional Configuration of the HMD According to the First Embodiment]

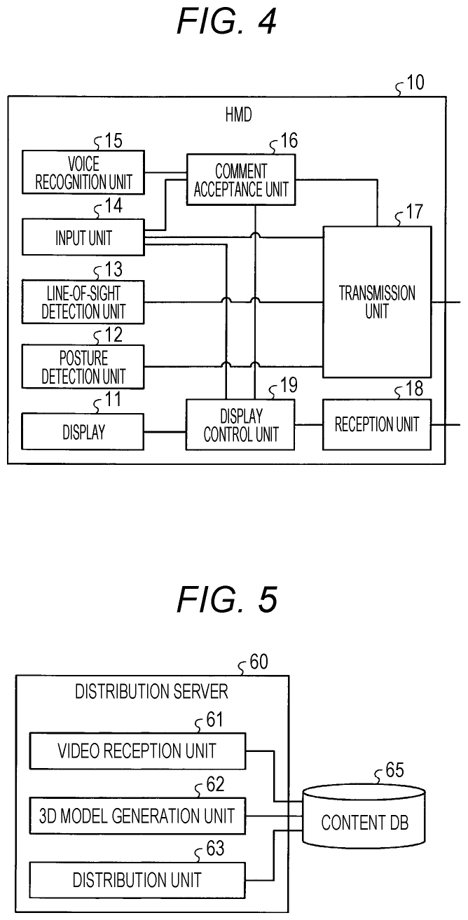

FIG. 4 is a diagram illustrating an example of a functional configuration of the HMD according to the first embodiment. As illustrated in FIG. 4, the HMD 10 includes a display 11, a posture detection unit 12, a line-of-sight detection unit 13, an input unit 14, a voice recognition unit 15, a comment acceptance unit 16, a transmission unit 17, a reception unit 10, and a display control unit 19. Each processing unit is realized by executing a program stored inside the HMD 10 using a random access memory (RAM) and the like as a work area by, for example, a central processing unit (CPU), a micro processing unit (MPU), and the like. Also, each processing unit may be realized by an integrated circuit, for example, such as an application-specific integrated circuit (ASIC), a field-programmable to array (FPGA), and the like.

The display 11 is a display device corresponding to, for example, an organic electro-luminescence (EL) display, a liquid crystal display, and the like. The display 11 displays information input from the display control unit 19. The information input from the display control unit 19 includes the free viewpoint video, a comment arranged on the free viewpoint video, and the like.

The posture detection unit 12 is a processing unit that detects various information regarding the user's movements such as the orientation, inclination, motion, movement speed, and the like of the user's body by controlling a sensor (not illustrated in the drawings) included in the HMD 10. For example, the posture detection unit 12 detects the orientation of the face and the like as information regarding the user's movement. The posture detection unit 12 outputs various information regarding the user's movement to the transmission unit 17.

For example, the posture detection unit 12 controls various motion sensors such as a 3-axis acceleration sensor, a gyro sensor, a speed sensor, and the like as sensors and detects information regarding the user's movement. Note that the sensor does not necessarily need to be provided inside the HMD 10 and may be, for example, an external sensor connected to the HMD 10 via a wired line or wirelessly.

The line-of-sight detection unit 13 is a processing unit that detects the user's line-of-sight position on the display 11 based on an image of the user's eye captured by a camera (not illustrated in the drawings) included in the HMD 10. For example, the line-of-sight detection unit 13 detects the inner corner of the eve and the iris in the image of the user's eye captured by the camera, sets the inner corner of the eye as the reference point and the iris as the moving point, and specifies the line-of-sight vector on the basis of the reference point and the moving point. The line-of-sight detection unit 13 detects the user's line-of-sight position on the display 11 from the line-of-sight vector and the distance between the user and the display 11. The line-of-sight detection unit 13 outputs information regarding the line-of-sight position to the transmission unit 17. Note that the line-of-sight detection unit 13 may perform a process other than described above to detect the line-of-sight position.

The input unit 14 corresponds to an input device such as a keyboard, a remote controller, and the like used in a case where the user inputs the comment. In a case where accepting the input of the, comment, the input unit 14 outputs the comment information to the comment acceptance unit 16. The user operates the input unit 14 to specify the viewpoint information regarding the viewpoint position and direction of the free viewpoint video. In a case where accepting the designation of the viewpoint information, the input unit 14 outputs the viewpoint information to the transmission unit 17. The user can also operate the input unit 14 to request to change the target. The input unit 14 outputs the change request information of the target to the transmission unit 17. Also, the user may operate the input unit 14 to input user identification information that uniquely identifies the user.

The voice recognition unit 15 is a processing unit that recognizes a user's voice comment input via a microphone (not illustrated in the drawings) and converts the voice comment into a character string comment. The voice recognition unit 15 outputs the converted comment information to the comment acceptance unit 16.

The comment acceptance unit 16 is a processing unit that accepts the comment information from the input unit 14 or the voice recognition unit 15. In a case where accepting the comment information, the comment acceptance unit 16 also acquires information regarding the time when accepting the comment information from a timer (not illustrated in the drawings). The comment acceptance unit 16 outputs the received comment information and the time information to the transmission unit 17 and the display control unit 19. Note that in a case where the button for post 11b is pressed while the confirmation screen 11a (FIG. 3) is displayed on the display 11, the comment acceptance unit 16 outputs the comment information displayed in the comment field 11d to the transmission unit 17.

Note that, in a case where the user operates the input unit 14 to input a comment, it is also possible to input the comment without specifying a specific target. For example, in a case where inputting a comment after the user presses a predetermined button, the comment acceptance unit 16 accepts it as comment information that does not designate a target and outputs the accepted comment information to the transmission unit 17. A comment that does not designate a target is a comment in a case where the comment is for the entire game such as “It's a good game” or for a plurality of players. It is possible to say that comment information posted to a specific player (target), comment information posted to a plurality of players, comment information posted to the entire team, and comment information posted to the entire game is related information related to the free viewpoint video. Also, as comment information, it is possible to display various information such as a player's profile, a player's performance, and the like.

The transmission unit 17 is a processing unit that transmits various types of information received from each processing unit to the information processing device 100. For example, the transmission unit 17 transmits the comment information (comment content) received from the comment acceptance unit 16 and the information regarding the time when accepting the comment to the information processing device 100. The transmission unit 17 transmits the viewpoint information accepted from the input unit 14 to the information processing device 100. The transmission unit 17 transmits the information regarding the line-of-sight position accepted from the line-of-sight detection unit 13 to the information processing device 100. The transmission unit 17 transmits various information regarding the user's operation accepted from the posture detection unit 12 to the information processing device 100. The transmission unit 17 transmits the user identification information to the information processing device 100. Also, in a case where accepting the change request information of the target, the transmission unit 17 transmits the change request information to the information processing device 100.

The reception unit 18 is a processing unit that receives information of the free viewpoint video from the information processing device 100. The reception unit 18 outputs the information of the free viewpoint video to the display control unit 19.

The display control unit 19 is a processing unit that outputs the information of the free viewpoint video to the display 11 to display the free viewpoint video. Also, the display control unit 19 may display the confirmation screen 11a on the display 11. In a case where causing the confirmation screen 11a to be displayed, the display control unit 19 causes the comment accepted from the comment acceptance unit 16 to be displayed in the comment field 11d.

### [1-4. Functional Configuration of the Distribution Server According to the First Embodiment]

FIG. 5 is a diagram illustrating an example of a functional configuration of the distribution server according to the first embodiment. As illustrated in FIG. 5, the distribution server 60 includes a video reception unit 61, a 3D model generation unit 62, a distribution unit 63, and a content DB 65. Each processing unit is realized by, for example, a CPU, an MPU, and the like executing a program stored inside the distribution server 60 using a RAM and the like as a work area. Also, each processing unit may be realized by, for example, an integrated circuit such as an ASIC, an FPGA, and the like.

The video reception unit 61 is connected to a plurality of cameras (not illustrated in the drawings). For example, a plurality of cameras is respectively arranged at a plurality of positions on a court where a sports game is played and shoots the court from different viewpoint positions. The video reception unit 61 stores the video received from the plurality of cameras in the content DB 65 as multi-viewpoint video information.

The 3D model generation unit 62 is a processing unit that analyzes the multi-viewpoint video information stored in the content DB 65 and generates 3D models of objects. Objects correspond to players playing sports on the court, balls, and the like. The 3D model generation unit 62 assigns coordinates of the 3D model and the identification information to each generated 3D model. The 3D model generation unit 62 stores information of the generated 3D model in the content DB 65. Also, the 3D model generation unit 62 determines whether the 3D model is a player, a ball, or an object (goal post and the like) on the field from the characteristics of the 3D model and the like, and gives a label indicating the determined type of the 3D model to each 3D model.

The distribution unit 63 is a processing unit that distributes the content information stored in the content DB 65 to the information processing device 100.

FIG. 6 is a diagram illustrating an example of a data structure of the content DB. As illustrated in FIG. 6, this content DB65 associates the time, the multi-viewpoint video information, and the 3D model information with each other. The multi-viewpoint video information is information stored by the video reception unit 61 and is video information captured by each camera. The 3D model information is the information of the 3D model of each object generated by the 3D model generation unit 62. Each 3D model of the 3D model information is associated with the identification information of the 3D model (object) and the coordinates. Also, it is possible to give a label that can identify the player's region (face, torso, legs, arms, and the like) to each area of the 3D model.

### [1-5. Functional Configuration of the Comment Management Server According to the First Embodiment]

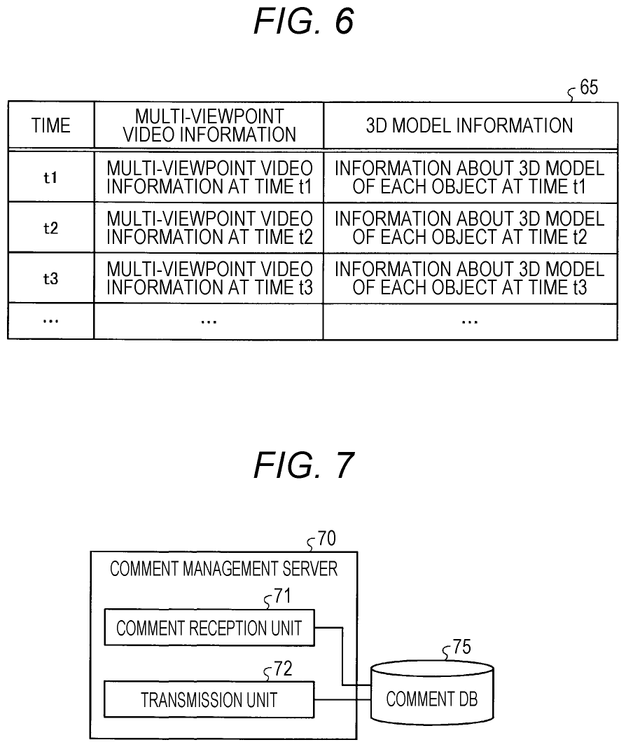

FIG. 7 is a diagram illustrating an example of a functional configuration of the comment management server according to the first embodiment. As illustrated in

FIG. 7, the comment management server 70 has a comment reception unit 71 and a transmission unit 72. Each processing unit is realized by, for example, a CPU, an MPU, and the like executing a program stored inside the comment management server 70 using a RAM and the like as a work area. Also, each processing unit may be realized by, for example, an integrated circuit such as an ASIC, an FPGA, and the like.

The comment reception unit 71 is a processing unit that receives the comment information posted by each user from the information processing device 100 or another information processing device. The comment reception unit 71 stores the received comment information in the comment DB 75.

The transmission unit 72 is a processing unit that reads the comment information stored in the comment DB 75 and transmits it to the information processing device 100 or another information processing device.

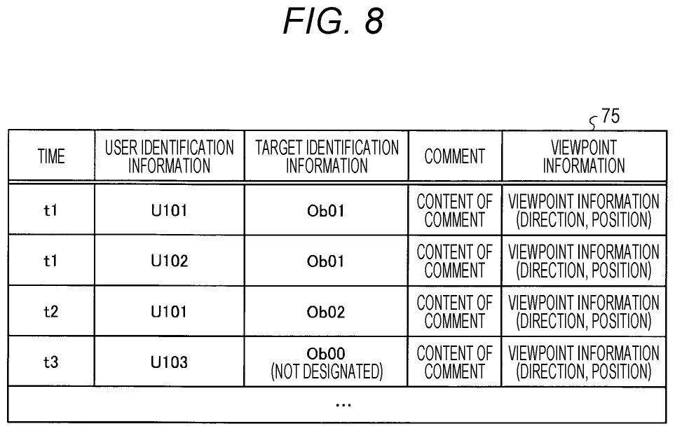

FIG. 8 is a diagram illustrating an example of a data structure of the comment DB. As illustrated in FIG. 8, the comment DB 75 associates time, user identification information, target identification information, a comment, and viewpoint information with each other. The user identification information is information that uniquely identifies the user who posted the comment. The target identification information is information that uniquely identifies the object (target) to which the comment is posted. The comment is information corresponding to the content of the posted comment. The viewpoint information is information indicating the direction and position of the virtual camera set when generating the free viewpoint video.

### [1-6. Functional Configuration of the Information Processing Device According to the First Embodiment]

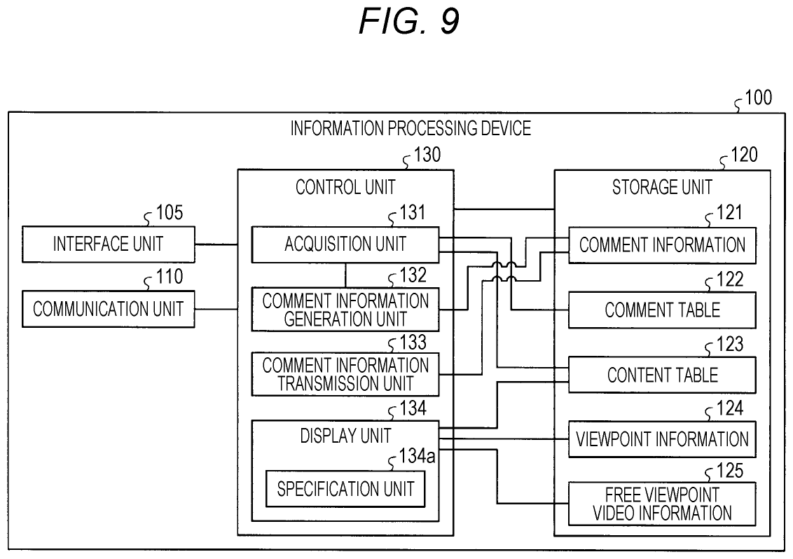

FIG. 9 is a diagram illustrating an example of a functional configuration of the information processing device according to the first embodiment. As illustrated in FIG. 9, the information processing device 100 includes an interface unit 105, a communication unit 110, a storage unit 120, and a control unit 130.

The interface unit 105 is a processing unit that is connected to the HMD 10 wirelessly or via a wired line and executes data communication with the HMD 10. The control unit 130, which will be described later, exchanges data with the HMD 10 via the interface unit 105.

The communication unit 110 is a processing unit that connects to the network 50 wirelessly or via a wired line and executes data communication with the distribution server 60 and the comment management server 70 via the network 50. The control unit 130, which will be described later, exchanges data with the distribution server 60 and the comment management server 70 via the communication unit 110.

The storage unit 120 has, for example, comment information 121, a comment table 122, a content table 123, viewpoint information 124, and free viewpoint video information 125. The storage unit 120 corresponds to a storage device, for example, such as a semiconductor memory element such as the PAM, a read-only memory (ROM), a flash memory, and the like.

The comment information 121 is information regarding the comment input by the user 5. For example, the comment information 121 includes time when the comment is input, user identification information viewpoint information, target identification information, a content of a comment, and viewpoint information. This comment information 121 is reported to the comment management server 70.

The comment table 122 is a table that stores the comment information of each user transmitted from the comment management server 70. The comment information of each user transmitted from the comment management server 70 is the information stored in the comment DB 75 described with reference to FIG. 8.

The content table 123 is a table that stores content information distributed from the distribution server 60. The content information distributed from the distribution server 60 is the information stored in the content DB 65 described with reference to FIG. 6.

The viewpoint information 124 is information indicating the viewpoint position and direction of the virtual camera and is used when generating the free viewpoint video information 125. The viewpoint information 124 corresponds to the viewpoint information transmitted from the HMD 10. Also, the viewpoint information 124 is changed to the viewpoint information in which the area of the target and the area of the comment included in the free viewpoint video do not overlap by the processing of the control unit 130 described later.

The free viewpoint video information 125 is the information of the free viewpoint video in a case where the virtual camera is arranged based on the viewpoint information 124. The free viewpoint video information 125 is generated by the display unit 134 described later.

The control unit 130 includes an acquisition unit 131, a comment information generation unit 132, a comment information transmission unit 133, and a display unit 134. Each processing unit included in the control unit 130 is realized by, for example, a CPU, an MPU, and the like executing a program stored inside the storage unit 120 using a RAM and the like as a work area. Also, each processing unit may be realized by, for example, an integrated circuit such as an ASIC, an FPGA, and the like.

The acquisition unit 131 acquires the content information from the distribution server 60 and stores the acquired content information in the content table 123. The acquisition unit 131 acquires the comment information from the comment management server 70 and stores the acquired comment information in the comment DB 75.

The acquisition unit 131 acquires various information regarding a comment from the HMD 10 and outputs the acquired information to the comment information generation unit 132. For example, various information regarding the comment includes the time when the comment is input, the user identification information viewpoint information, the content of the comment, the viewpoint information, and the information regarding the line-of-sight position. Also, in a case where accepting the change request information from the HMD 10, the acquisition unit 131 outputs the change request information to the comment information generation unit 132.

The comment information generation unit 132 is a processing unit that generates the comment information 121 of the user 5 to be reported to the comment management server 70 and stores it in the storage unit 120. Among each of the information included in the comment information 121, regarding the time when the comment was input, the user identification information viewpoint information, the content of the comment, and the viewpoint information, the comment information generation unit 132 stores the information transmitted from the HMD 10 in the comment information 121 as is. Regarding the target identification information of the comment information 121, it is specified by the comment information generation unit 132 by executing the following processing.

The comment information generation unit 132 specifies an object that collides with the line-of-sight direction of the user 5 on the basis of the viewpoint information, the information regarding the line-of-sight position, the coordinates of the 3D model of the object in the content table 123, and the like and specifies the information that identifies the specified object uniquely as the target identification information. The comment information generation unit 132 stores the specified target identification information in the comment information 121. The comment information generation unit 132 generates comment information 121 each time acquiring various information regarding a comment from the acquisition unit 131.

Note that, in a case where the change request information is acquired, the comment information generation unit 132 changes the target identification information. For example, in a case where the change request information is accepted, the comment information generation unit 132 regards a 3D model closest to the 3D model corresponding to the target identification information of the content table 123 as a new target and regards the identification information of this target as new target identification information. Each time the change request information is accepted, the comment information generation unit 132 selects a 3D model unselected as a target yet sequentially and changes the target identification information.

The comment information transmission unit 133 is a processing unit that transmits the comment information 121 to the comment management server 70. If The new comment information 121 is generated, the comment information transmission unit 133 transmits the generated comment information 121 to the comment management server 70.

The display unit 134 is a processing unit that generates the free viewpoint video information 125 and outputs the generated free viewpoint video information 125 to the HMD 10 to display it. Also, the display unit 134 has a specification unit 134a that specifies viewpoint information in which the area of the object and the area of the comment do not overlap.

First, an example of processing in which the display unit 134 generates the free viewpoint video information will be described. The display unit 134 generates the free viewpoint video information 125 in a case where the virtual camera is arranged at the position and direction set in the viewpoint information 124, on the basis of the content information stored in the content table 123. For example, the display unit 134 arranges the virtual camera in the virtual space on the basis of the viewpoint information 124 and specifies an object included in a shooting range of the virtual camera. The display unit 134 generates the free viewpoint video information 125 by executing processing such as rendering and the like on the 3D model of the specified object. The display unit 134 may use other free viewpoint video technology other than the above-described processing in a case where generating the free viewpoint video information 125. In a case where generating the free viewpoint video information 125, the display unit 134 specifies the area of each object included in the free viewpoint video information 125 and the object identification information for each object.

When the free viewpoint video information 125 is generated, the display unit 134 refers to the comment table 122 and specifies an object corresponding to the target identification information of the comment among the objects included in the free viewpoint video information 125. In the following description, an object corresponding to the target identification information is referred to as “a target” as appropriate. The display unit 134 associates the target with the comment and performs processing of arranging the comment in the free viewpoint video information 125.

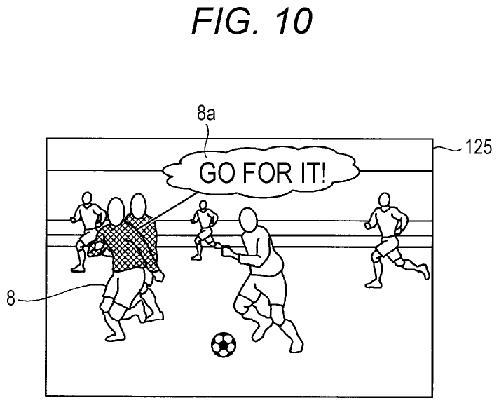

FIG. 10 is a diagram illustrating an example of the free viewpoint video information in which a comment is arranged. In the free viewpoint video information 125 illustrated in FIG. 10, a comment 8a posted to the target 8 is included. That is, the target identification information corresponding to the comment 8a corresponds to the identification information of the target 8. The display unit 134 may connect the target 8 to the comment 8a with an arrow and the like.

In a case where causing the comment 8a to be displayed on the free viewpoint video information 125, the display unit 134 performs processing of causing the comment 8a to follow the target 8 in accordance with the movement of the target 8. In a case where the motion of the target 8 is intense, the display unit 134 may slow down the movement of the comment 8a or may make the comment 8a stationary and move only the arrow connecting the comment 8a to the target 8.

For example, the display unit 134 fixes the position of the comment in a case where the moving distance of the target per unit time (for example, 1 second) is less than a predetermined distance. The display unit 134 causes the comment to follow the target in a case where the distance between the comment position and the target becomes equal to or more than a preset distance.

After a certain time has elapsed after causing the comment to be displayed, the display unit 134 fades out it. If the display unit 134 detects that the comment is being looked based on the line-of-sight information of the user 5, the timing of fading out the comment being looked may be delayed by a predetermined time. On the other hand, in a case where there is a predetermined number or more of comment information per unit time, the display unit 134 may advance the timing of fading out the comment by a predetermined time.

In comments (comment information) stored in the comment table 122, there are also some comments that do not designate a specific target. For example, among the comment information of the comment DB 75 described in FIG. 8, the comment information whose target identification information is “Ob00” is the comment information that does not designate a specific target. In a case where the comment does not designate a specific target, the display unit 134 causes the comment to be displayed in a predetermined area of the free viewpoint video information 125.

Here, the specification unit 134a of the display unit 134 performs processing of changing the viewpoint information 140 so that the area of the object and the area of the comment do not overlap in a case where displaying the comment on the free viewpoint video information 125. For example, the specification unit 134a calculates an area for causing a comment to be displayed on the basis of the number of characters of the comment made to be displayed in the free viewpoint video information 125 and the size of the font designated in advance. In the following description, the area for causing the comment to be displayed will be referred to as “a comment area”.

The specification unit 134a specifies the player's object included in the free viewpoint video information 125 and specifies the area of the player's object. In the following, the area of the player's object will be referred to as “an object area”.

The specification unit 134a determines whether or not the remaining area excluding the object area from the entire area of the free viewpoint video information 125 is larger than the comment area. In a case where the remaining area is larger than the comment area, the specification unit 134a arranges a comment in the remaining area and skips the processing of changing the viewpoint information 140. On the other hand, the specification unit 134a performs processing of changing the viewpoint information 124 in a case where the remaining area is smaller than the comment area. In the following, a plurality of processes in which the specification unit 134a changes the viewpoint information 124 will be described, but the specification unit 134a may perform any of the processes.

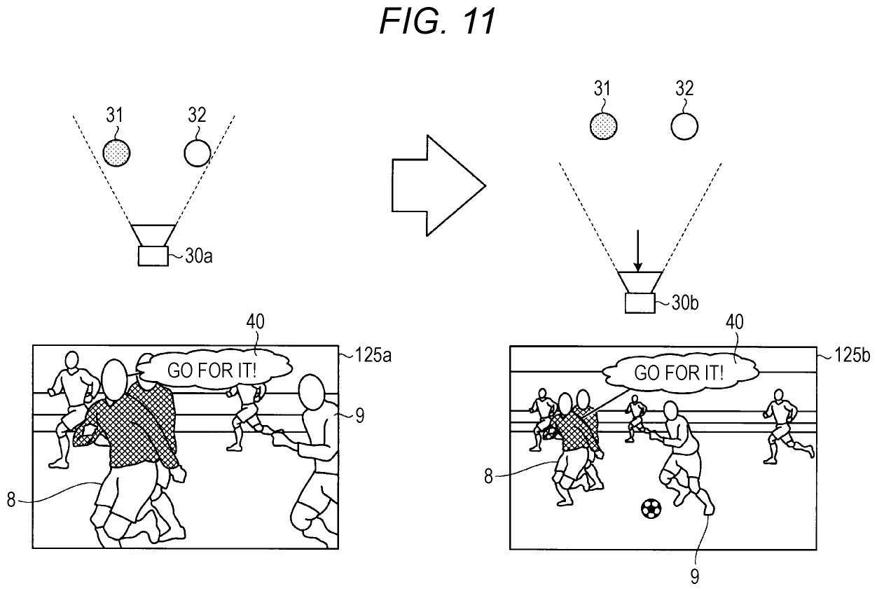

FIG. 11 is Diagram (1) for explaining a process in which the specification unit changes the viewpoint information. In the description of FIG. 11, the free viewpoint video information 125a is the information of the free viewpoint video based on the viewpoint position 30a. For example, the position of the target 8 on the free viewpoint video information 125a is set to a position 31, and the position of the object 9 is set to a position 32. Since the viewpoint posit on 30a is close to the position 31 of the target 8, a part of the comment area 40 overlaps the area of the target 8.

Since the comment area 40 and the area of the target 8 overlap. The specification unit 134a sets a new viewpoint position by moving the viewpoint position 30a in the direction opposite to the positions 31 and 32. The new viewpoint position is a viewpoint position 30b. The free viewpoint video information 125b is the information of the free viewpoint video based on the viewpoint position 30b. That is, the specification unit 134a changes the viewpoint position of the viewpoint information 124 from the viewpoint position 30a to the viewpoint position 30b to generate the free viewpoint video information 125b. In the free viewpoint video information 125b, the comment area 40 does not overlap the area of the target 8.

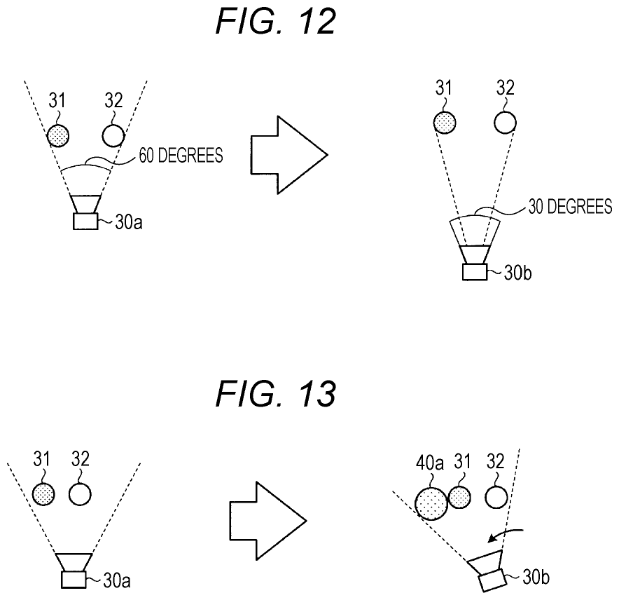

FIG. 12 is a diagram illustrating an example of a change in an angle of view as a viewpoint moves. For example, in a case where the viewpoint position is a viewpoint position 30a, an angle of view of 60 degrees is required to display an object at a position 31 and an object at a position 32 on the free viewpoint video information 125a. On the other hand, if the viewpoint position is backed out to a viewpoint position 30b behind a viewpoint position 30a, the angle of view for displaying the object at the position 31 and the object at the position 32 becomes narrower, and it is possible to secure a comment area. For example, in a case where the distance between the viewpoint position 30b and the object position 31 is twice the distance between the viewpoint position 30a and the object position 31, the angle of view required to display the object at the position 31 and the object at the position 32 on the free viewpoint video information 125b is 30 degrees, and empty space of 30 degrees is created. It is possible to display the comment information in this area.

FIG. 13 is Diagram (2) for explaining a process in which the specification unit changes the viewpoint information. For example, it is assumed that the specification unit 134a lacks the comment area when the free viewpoint video information 125 is generated on the basis of the viewpoint position 30a. The specification unit 134a secures the comment area 40a by rotating the direction of the virtual camera while keeping the viewpoint position as is. For example, the specification unit 134a rotates the direction of the virtual camera by a predetermined rotation angle to secure the comment area 40a, and in a case where the comment area 40a is insufficient, the direction of the virtual camera may be further rotated. By the way, in a case where the first comment is at the position 31, the specification unit 134a keeps the viewpoint position as is even in a case where causing the second comment related to the first comment such as the post for the first comment and the like to be displayed and rotates the direction of the virtual camera to secure a comment area. Also, in a case where the comment for the object 32 exists and the comment area for displaying the comment is insufficient, the specification unit 134a can secure the comment area by rotating the direction of the virtual camera to the right.

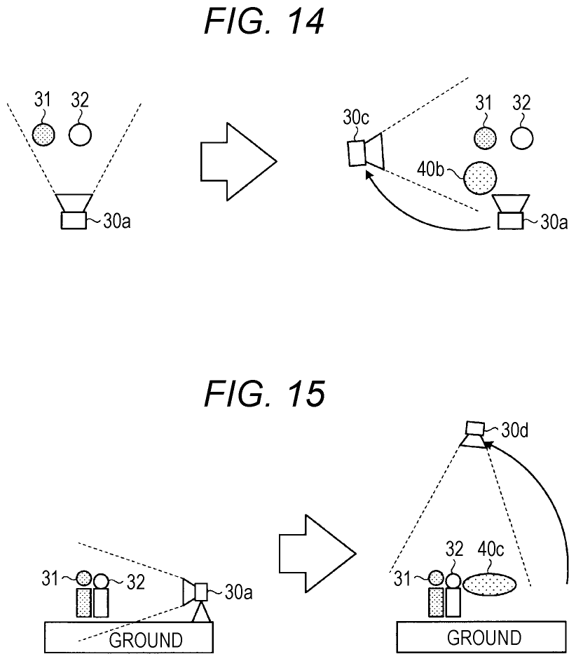

FIG. 14 is Diagram (3) for explaining a process in which the specification unit changes the viewpoint information. For example, it is assumed that the display unit 134 lacks the comment area when the free viewpoint video information 125 is generated on the basis of the viewpoint position 30a. The specification unit 134a secures the comment area 40b by changing the viewpoint position 30a to the viewpoint position 30c and directing the direction of the virtual camera toward the positions 31 and 32. The specification unit 134a may move the viewpoint position by setting a constrained condition such as a target included in the free viewpoint video information based on the viewpoint position 30a before movement is also included in the free viewpoint video based on the viewpoint position (position and direction) 30b after movement and the like.

FIG. 15 is Diagram (4) for explaining a process in which the specification unit changes the viewpoint information. For example, it is assumed that the display unit 134 lacks the comment area when the free viewpoint video information 125 is generated on the basis of the viewpoint position 30a. The specification unit 134a secures the comment area 40c by changing the viewpoint position 30a to the viewpoint position 30d and directing the direction of the virtual camera toward the positions 31 and 32. The free viewpoint video generated on the basis of the viewpoint position 30d is a bird's-eye view image. The specification unit 134a may move the viewpoint position by setting a constrained condition such as a target included in the free viewpoint video information based on the viewpoint position 30a before movement is also included in the free viewpoint video based on the viewpoint position (position and direction) 30d after movement and the like.

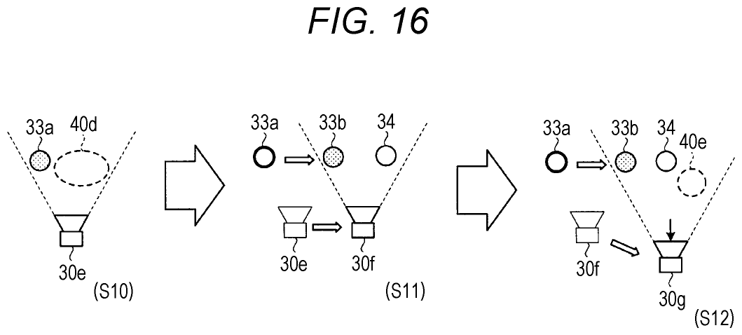

FIG. 16 is Diagram (5) for explaining a process which the specification unit changes the viewpoint information. In a case where following a target (player, ball, or the like), the specification unit 134a not only keeps the viewpoint position constant with the target but also sets the viewpoint position for securing the comment area. In step S10, it is assumed that the first viewpoint position is a viewpoint position 30e and the target is located at a position 33a. At the stage of step S10, a comment area 40d is secured.

When detecting that the target moves from the position 33a to a position 33b in step S11, the specification unit 134a moves the viewpoint position 33e to a viewpoint position 30f in order to keep the distance between the target and the virtual camera constant. For example, the specification unit 134a determines that the comment area cannot be secured in a case where the viewpoint position 30e is moved to the viewpoint position 30f.

In step S12, the specification unit 134a secures a comment area 40e by moving the viewpoint position 30f to a viewpoint position 30q. For example, the specification unit 134a moves the viewpoint position so as to increase the distance between the target position 33b and the start point position. Here, the free viewpoint video information 125 based on the viewpoint position 30g is generated, and in a case where the ratio of the area other than the comment area and the object area (the ratio of the remaining area) to the entire area of the free viewpoint video information 125 is equal to or more than a certain ratio, the specification unit 134a may perform a process of moving the viewpoint position 30g forward.

The specification unit 134a of the display unit 134 performs the process of changing the viewpoint information 124 described above, generates the free viewpoint video information 125, outputs it to the HMD 10 to display it. Also, the display unit 134 performs a process of causing a frame to be displayed on the object to become the target among each of the objects included in the free viewpoint video information 125 on the basis of the target identification information specified by the comment information generation unit 132.

Note that, in a case where the viewpoint information 124 is changed to generate the free viewpoint video information 125 and display it on the HMD 10, the display unit 134 may accept information from the user 5 as to whether or not to allow the viewpoint information 124 to be changed. For example, in a case where accepting the input of the operation that the user 5 does not allow the viewpoint information 124 to be changed, the display unit 134 may return it to the viewpoint information 124 before the change.

Also, the user 5 may set a favorite viewpoint change pattern in the information processing device 100. For example, among the change in the viewpoint information 124 that the viewpoint position is backed out illustrated in FIG. 11, the change in the viewpoint information 124 that the direction of the virtual camera is changed illustrated in FIG. 13, the change in the viewpoint information 124 that the virtual camera is changed in the horizontal direction described in FIG. 14, and the change in the viewpoint upper 124 that the position of the virtual camera is changed upward described in FIG. 15, an allowable change process is selected. By selecting the change process allowed by the user 5 in this way, the user's favorite free viewpoint video information can be continuously viewed.

### [1-7. Processing Procedure of the Information Processing Device According to the First Embodiment]

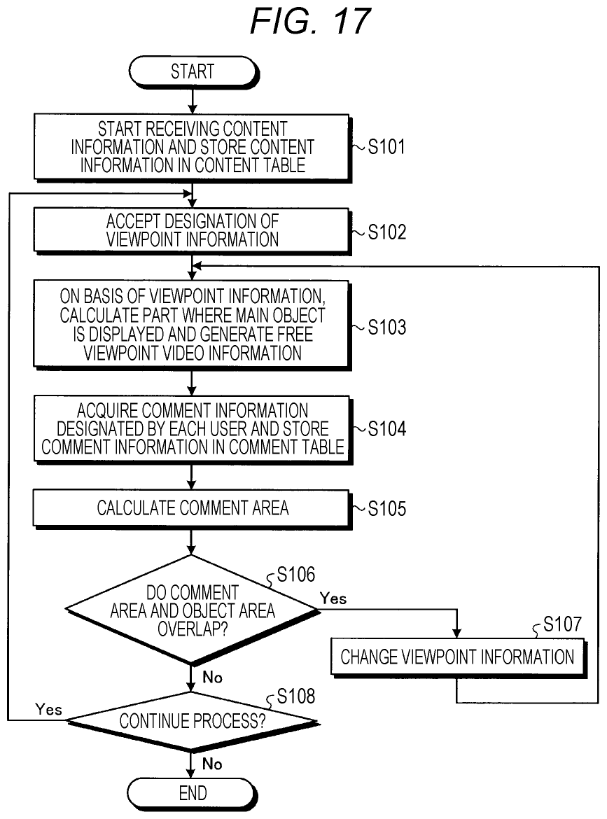

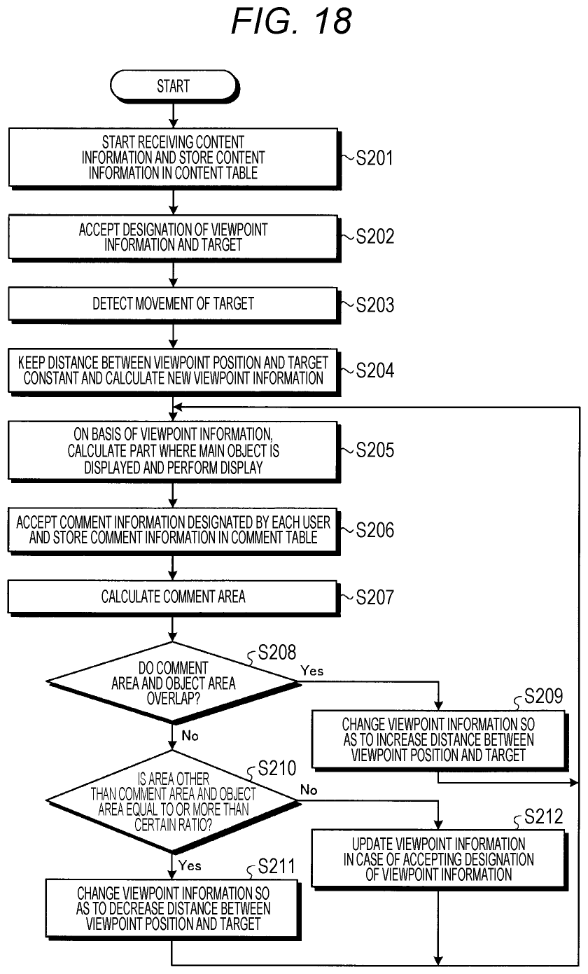

FIGS. 17 and 18 are flowcharts illustrating processing procedures of the information processing device according to the first embodiment. FIG. 17 illustrates an example of a processing procedure in a case where the designation of the viewpoint information is accepted from HMD 10. The acquisition unit 131 of the information processing device 100 starts receiving the content information from the distribution server 60 and stores the content information in the content table 123 (step S101). The acquisition unit 131 accepts the designation of the viewpoint information 124 from the HMD 10 (step S102).

The display unit 134 of the information processing device 100 calculates the part where the main object is displayed on the basis of the viewpoint information 124 and generates the free viewpoint video information 125 (step S103). The acquisition unit 131 acquires the comment information designated by each user from the comment management server 70 and stores it in the comment table 122 (step S104).

The display unit 134 acquires the comment information stored in the comment table 122 and calculates the comment area of the comment (step S105). The display unit 134 determines whether or not the comment area and the object area overlap (step S106).

In a case where the comment area and the object area overlap (step S106, Yes), the display unit. 134 changes the viewpoint information 124 (step S107) and proceeds to step S103. On the other hand, the display unit 134 proceeds to step S108 in a case where the comment area and the object area do not overlap (step S106, No).

The display unit 134 determines whether or not to continue the process (step S108). In a case where continuing the process (step S108, Yes), the display unit 134 proceeds to step S102. On the other hand, in a case where not continuing the process (step S108, No), the display unit 134 finishes the process.

FIG. 18 will be described. FIG. 18 illustrates an example of a processing procedure for updating the viewpoint information 124 in a case where the target moves. The acquisition unit 131 of the information processing device 100 starts receiving the content information from the distribution server 60 and stores the content information in the content table 123 (step S201). The acquisition unit 131 accepts the designation of the viewpoint information 124 and the target from the HMD 10 (step S202).

The display unit 134 of the information processing device 100 detects the movement of the target (step S203). The display unit 134 keeps the distance between the viewpoint position and the target constant and calculates new viewpoint information 124 (step S204).

The display unit 134 calculates the part where the main object is displayed on the basis of the viewpoint information 124 and displays the free viewpoint video information 125 (step S205). The acquisition unit 131 acquires the comment information input by each user from the comment management server 70 and stores it in the comment table 122 (step S206).

The display unit 134 acquires the comment information stored in the comment table 122 and calculates the comment area of the comment (step S207). The display unit 134 determines whether or not the comment area and the object area overlap (step S208).

In a case where the comment area and the object area overlap (step S208, Yes), the display unit 134 changes the viewpoint information 124 so as to increase the distance between the viewpoint position and the target (step S209) and proceeds to step S205.

On the other hand, in a case where the comment area and the object area do not overlap (step S208, No), the display unit 134 proceeds to step S210. The display unit 134 determines whether or not the area other than the comment area and the object area is equal to or more than a certain ratio with respect to the entire area of the free viewpoint video information 125 (step S210).

In a case where the area other than the comment area and the object area is equal to or more than the certain ratio (step S210, Yes), the display unit 134 changes the viewpoint information 124 so as to decrease the distance between the viewpoint position and the target (step S211) and proceeds to step S205.

In a case where the area other than the comment area and the object area is not equal to or more than the certain ratio (step S210, No), the display unit 134 proceeds to step S212. In a case where the designation of the viewpoint information is accepted from the HMD 10, the acquisition unit 131 updates the viewpoint information 124 (step S212) and proceeds to step S205.

### [1-8. Effect of Information Processing Device According to the First Embodiment]

As described above, the information processing device 100 according to the first embodiment changes the viewpoint information 124 so that the object area and the comment area do not overlap and, in order to display a comment on the free viewpoint video based on the changed viewpoint information 124, in a case where the input of the comment regarding the object in the moving image is accepted, can display the object area and the comment area so as not to overlap. For example, the information processing device 100 can narrow the angle of view for causing the target and other objects to be displayed by moving the viewpoint position in the direction opposite to the target, and it is thereby possible to secure the comment area.

In a case where the target of the comment moves, the information processing device 100 performs a process of causing the comment to follow the target while keeping the position of the target and the viewpoint position constant. Also, in a case where the comment area and the target area overlap in the process of causing the comment to follow the target, the information processing device 100 secures the comment area by, for example, moving the viewpoint position in the direction opposite to the target. Therefore, it is possible to continuously prevent the target and the comment from overlapping.

After securing the comment area by moving the viewpoint position in the direction opposite to the target, in a case where the ratio of the area excluding the comment area and the object area to the entire area of the free viewpoint video is equal to or more than a certain ratio, the information processing device 100 moves the viewpoint position so as to return to the target direction. Therefore, it is also possible to prevent the viewpoint position from being separated from the position of the target beyond necessity.

In a case where moving the viewpoint, the information processing device 100 performs a process of changing the viewpoint information of the virtual camera in the horizontal direction or the upward direction. Therefore, the user can watch the video of the game from various directions while referring to the comments posted by each user. Also, in a case where moving the viewpoint information 124 to generate the free viewpoint video information 125, causing the HMD 10 display to be performed, and accepting an instruction from the user 5 that the viewpoint change is not allowed, by performing the process of returning the viewpoint information 124 to the viewpoint information 124 before the change, the information processing device 100 can provide the free viewpoint video that fits in the preference of the user who views the video.

In a case where the moving distance of the target per unit time (for example, 1 second) is less than a predetermined distance, the information processing device 100 performs a process of fixing the position of the comment. As a result, it is possible to prevent the comment from moving following the target that moves in small steps, making it difficult to see.

After a certain time has elapsed after causing the comment to be displayed, the information processing device 100 fades out it. Also, when detecting that the comment is being looked on the basis of the line-of-sight information of the user 5, the information processing device 100 delays the timing of fading out the comment being looked by a predetermined time. Also, in a case where there is a predetermined number or more of comment information per unit time, the information processing device 100 advances the timing of fading out the comment by a predetermined time. By performing such processing by the information processing device 100, the user can comfortably confirm the comment.

### 2. Modification Example of the First Embodiment

In the information processing system 1 described in the first embodiment described above, when a plurality of users performs viewing, a plurality of comments may be input to one target at the same time in some cases. In this case, if the information processing device 100 causes all the comments to be displayed on the free viewpoint video, it may not be possible to secure an area in which the comments can be displayed, or it may be difficult to see the player in some cases. Therefore, the display unit 134 refers to the comment table 122, and in a case where a plurality of pieces of comment information exists at the same time (or in a short time period) for one target identification information, priority is set for each comment information on the basis of the relationship between the reference user and other users. Here, the reference user is regarded as a user of the HMD 10 that the information processing device 100 causes the free viewpoint video information 125 to be displayed, and a user different from the user wearing the HMD 10 is regarded as a user using other than the HMD 10. The information processing device 100 performs a process of displaying only the top n comment information having high priorities on the free viewpoint video information of the reference user. Value n is a numerical value set as appropriate, for example, a natural number of 1 or more.

The display unit 134 may calculate the priority of the comment information in any way. After acquiring information regarding the conversation history between the reference user (for example, the user 5 illustrated in FIG. 1) and another user, the favorite list of the reference user, and friend information on social networking service (SNS) from an external device, the display unit 134 calculates the priority on the basis of such information. For example, the display unit 134 calculates the priority of the comment information on the basis of Equation (1).

Another user who has posted comment information for which priority is calculated is referred to as “a target user”. In Equation (1), “X1” is a value determined. according to the total conversation time between the reference user and the target user, and the longer the total conversation time, the larger the value. For “X2”, a predetermined value is set in a case where the target user is included in the favorite list of the reference user, and 0 is set in a case where the target user is not included in the favorite list. For “X3”, on SNS, a predetermined value is set in a case where the reference user and the target user have a friendship, and 0 is set in a case where there is no friendship. Values α, β, and γ are preset weights.

Priority=α*X1+β*X2+γ*X3 (1)

As described above, in a case where a plurality of pieces of comment information exists, the display unit 134 sets a priority for each comment information, and by displaying only the top n comment information having high priorities on the free viewpoint video information of the reference user, it is possible to make it easier to refer to a comment having a high priority for the user. For example, it is possible to prioritize and display comments that are more informative and familiar to the reference user.

Also, the display unit 134 refers to the comment table 122, and in a case where there is a plurality of comments having similar contents, those comments may collectively be displayed in a large size, they may be classified by type and displayed as icons, or the volume of comments may be converted into an effect and superimposed on the target for display. For example, in a case where comments such as “Go for it!” and “Now” are posted by a plurality of users, the display unit 134 displays each comment collectively. Here, in addition to consolidating similar comments, the display unit 134 counts the number of similar comments and causes the area of a large number of comments to be displayed making it larger than the area of a small number of comments. Also, the display unit 134 may display a large number of comments in a conspicuous color or highlight them. Therefore, this makes it easier to grasp which comments are posted by more users.

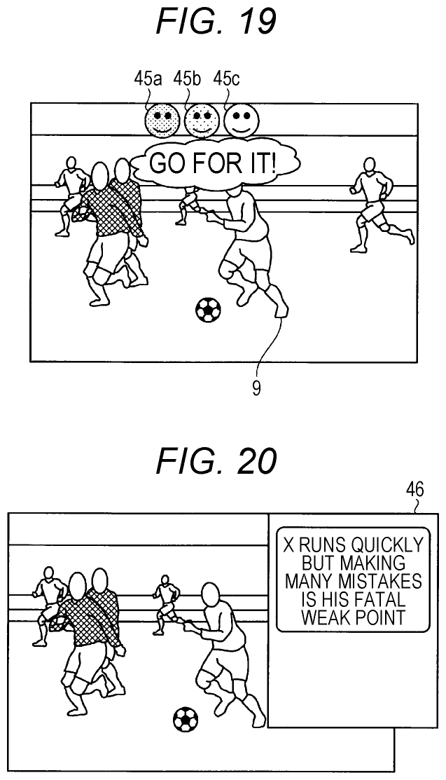

If there are many comments posted to the same target, the display unit 134 may display the posters' icons near the comments. FIG. 19 is Diagram (1) illustrating an example of a display screen according to a modification example of the first embodiment. In the example illustrated in FIG. 19, a case that the comment “Go for it!” posted to the same target 9 is illustrated. For example, in a case where this comment “Go for it!” is posted by the first user, the second user, and the third user, the display unit 134 causes the icons 45a, 45b, and 45c corresponding to the first user, the second user, and the third user to be displayed. Therefore, this makes it easy to confirm which user posted the comment.

In a case where the number of character strings included in the comment is equal to or more than a certain number, or in a case where the comment is posted to a plurality of people, the display unit 134 may display the comment on the user interface (UI) part or the like in the free viewpoint video. FIG. 20 is Diagram (2) illustrating an example of a display screen according to a modification example of the first embodiment. In the example illustrated in FIG. 20, the display unit 134 causes the comment to be displayed in the UI part 46 so that the comment does not overlap the target. By processing in this way, it is possible to prevent the viewpoint posit iron from being extremely far from the target in a case where the number of characters in the comment is large. Also, since it is possible to suppress the number of times the viewpoint position is changed, it is possible to reduce the load on the information processing device 100.

Note that the information processing device 100 may also generate comment information 121 and leave the history of the generated comment information 121 in the storage unit 120. For example, in a case where the designation of a certain comment by the user 5 is accepted via the HMD 10, the display unit 134 refers to the history and searches for the comment information corresponding to the accepted designated comment. The history of the comment information 121 includes metadata associated with comment posting, for example, the metadata such as user's viewpoint information at the time of comment posting and the like. The display unit 134 reproduces the free viewpoint video information at the time when the comment is posted, on the basis of the viewpoint information included in the specified comment information and the content information at the time when the comment is posted. As a result, the same free viewpoint video that is the basis of the comment posted in the past can be displayed to the user.

Also, the display unit 134 may analyze the content of the comment input by the user 5 and automatically set the viewpoint information 124. For example, if the input such as “I want to see the goal”, “Where is Player X?”, and the like is accepted as the comment, the viewpoint information 124 is set so that the object corresponding to the goal post and the object of the corresponding player will be included in the shooting range of the virtual camera. For example, the display unit 134 refers to the 3D model and the label of the content table 123, sets a position separated from the position of the 3D model corresponding to the goal by a processing distance as the viewpoint position, and generates the free viewpoint video information 125. Similarly, the display unit 134 refers to the 3D model and the label of the content table 123, sets a position separated from the position of the 3D model corresponding to the player relevant to the comment by a processing distance as the viewpoint position, and generates the free viewpoint video information 125. By executing such processing by the display unit 134, it is possible to easily set the viewpoint information 124 that is easy to refer to the target desired by the user.

The specification unit 134a of the display unit 134 changes the viewpoint information 124 so that the object area and the comment area do not overlap, but it is not limited to this, and it is also possible to change the viewpoint information 124 so that, of the area of the target (object area), the predetermined partial area and the comment area do not overlap. For example, the predetermined partial area is the area of the player's face and the area of the upper body. It is also possible to change the partial area as appropriate. In this way, by changing the viewpoint information 124 so that the predetermined partial area and the comment area do not overlap, the area where the comment can be displayed becomes large in comparison with the case of searching the comment area that does not overlap the entire target area, and it is possible to set the viewpoint information 124 easily.

In the present embodiment, the case that the HMD 10 displays the virtual reality (VR) free viewpoint video in the display 11 has been described, but it is not limited to this. For example, the HMD 10 may display an augmented reality (AR) video in the display 11. In this case, the information processing device 100 causes the comment information to be displayed in the display 11.

### 3 Second Embodiment

### [3-4. Configuration of Information Processing System According to the Second Embodiment]

Next, the second embodiment will be described. In the second embodiment, the processing according to the present disclosure is not performed on the server side such as the information processing device 100, but, on the display device side such as an HMD 80, generation of the free viewpoint video information, display of the comment, and the like according to the present disclosure are performed.

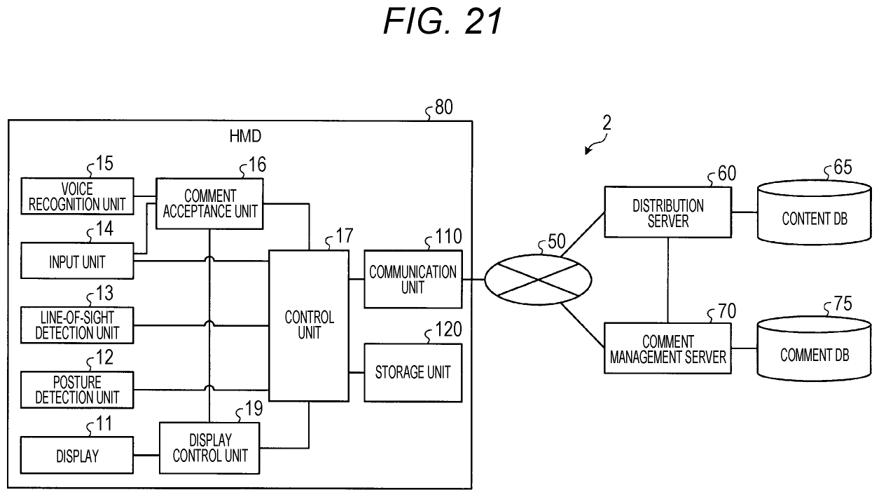

FIG. 21 is a diagram illustrating an example of an information processing system according to the second embodiment. As illustrated in FIG. 21, the HMD 80 included in the information processing system 2 includes a display 11, a posture detection unit 12, a line-of-sight detection unit 13, an input unit 14, a voice recognition unit 15, a comment acceptance unit 16, and a display control unit 19. Also, the HMD 80 includes a communication unit 110, a storage unit 120, and a control unit 130.

Descriptions regarding the display 11, the posture detection unit 12, the line-of-sight detection unit 13, the input unit 14, the voice recognition unit 15, the comment acceptance unit 16, and the display control unit 19 are similar to the descriptions regarding the display 11, the posture detection unit 12, the line-of-sight detection unit 13, the input unit 14, the voice recognition unit 15, the comment acceptance unit 16, and the display control unit 19 described with reference to FIG. 4.

The communication unit 110 of the HMD 80 is a processing unit that performs data communication with the distribution server 60 and the comment management server 70 via the network 50. The communication unit 110 receives the content information from the distribution server 60 and receives the comment information from the comment management server 70.

The storage unit 120 of the HMD 80 is a storage unit corresponding to the storage unit 120 of the information processing device 100 described with reference to FIG. 9. Although not illustrated in FIG. 21, the storage unit 120 includes comment information 121, a comment table 122, a content table 123, and free viewpoint video information 125.

The control unit 130 of the HMD 80 is a processing unit that executes similar processing as the control unit 130 of the information processing device 100 described with reference to FIG. 9. Although not illustrated in FIG. 21, the control unit 130 includes an acquisition unit 131, a comment information generation unit 132, a comment information transmission unit 133, and a display unit 134. Similarly to the information processing device 100, the control unit 130 generates free viewpoint video information on the basis of the viewpoint information 124, superimposes a comment on the generated free viewpoint video information, and causes the free viewpoint video information to be displayed on the display 11. Also, the control unit 130 changes the viewpoint information 124 so that the object area and the comment area do not overlap and causes a comment to be displayed on the free viewpoint video based on the changed viewpoint information 124.

As described above, the HMD 80 according to the second embodiment functions as the information processing device according to the present disclosure. That is, the HMD 80 can independently execute the process of generating the free viewpoint video information according to the present disclosure, without depending on the server device and the like. Note that it is also possible to combine the second embodiment with the modification example of the first embodiment.

Note that the effects described in the present specification are merely examples and are not limited, and may have other effects.

### (4. Hardware Configuration)

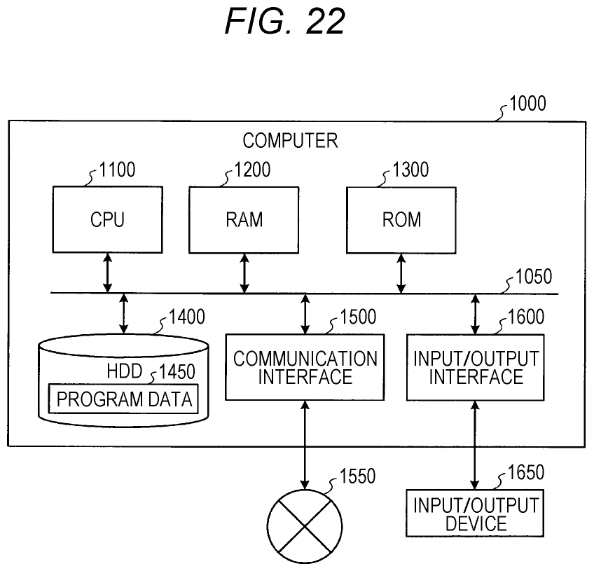

Information devices such as the information processing device, the HMD, the distribution server, the comment management server, and the like according to each of the embodiments described above are realized by a computer 1000 having a configuration as illustrated in FIG. 22, for example. Hereinafter, the information processing device 100 according to the first embodiment will be described as an example. FIG. 22 is a hardware configuration diagram illustrating an example of the computer 1000 that realizes the functions of the information processing device 100. The computer 1000 includes a CPU 1100, a RAM 1200, a read-only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400 and controls each unit. For example, the CPU 1100 expands a program stored in the ROM 1300 or the HDD 1400 in the RAM 1200 and executes processing corresponding to various programs.

The ROM 1300 stores a boot program such as a basic input-output system (BIOS) executed by the CPU 1100 when the computer 1000 starts up, a program dependent on the hardware of the computer 1000, and the like.

The HDD 1400 is a computer-readable recording medium that non-temporarily records a program executed by the CPU 1100, data used by the program, and the like. Specifically, the HDD 1400 is a recording medium for recording an information processing program according to the present disclosure, which is an example of program data 1450.

The communication interface 1500 is an interface for connecting the, computer 1000 to an external network 1550 (for example, the Internet). For example, the CPU 1100 receives data from another device or transmits the data generated by the CPU 1100 to another device via the communication interface 1500.

The input/output interface 1600 is an interface for connecting the input/output device 1650 and the computer 1000. For example, the CPU 1100 receives data from an input device such as a keyboard, a mouse, and the like via the input/output interface 1600. Also, the CPU 1100 transmits data to an output device such as a display, a speaker, a printer, and the like via the input/output interface 1600. Also, the input/output interface 1600 may function as a media interface for reading a program and the like recorded in a predetermined recording medium (medium). The medium is, for example, an optical recording medium such as a digital versatile disc (DVD), a phase change rewritable disk (PD), and the like, a magneto-optical recording medium such as a magneto-optical disk (MO) and the like, a tape medium, a magnetic recording medium, a semiconductor memory, or the like.

For example, in a case where the computer 1000 functions as the information processing device 100 according to the first embodiment, the CPU 1100 of the computer 1000 realizes the functions of the acquisition unit 131 and the like by executing the information processing program loaded on the RAM 1200. Also, the HDD 1400 stores the information processing program according to the present disclosure and the data stored in the storage unit 120. Note that the CPU 1100 reads the program data 1450 from the HDD 1400 and executes the program data, but as another example, it is possible to acquire these programs from another device via the external network 1550.

### (5. Effects of the Invention)

The information processing device includes an acquisition unit, a specification unit, and a display unit. The acquisition unit acquires related information related to the video. The specification unit specifies the second viewpoint different from the first viewpoint on the basis of the related information acquired by the acquisition unit and the video corresponding to the first viewpoint. The display unit causes the related information acquired by the acquisition unit to be displayed together with the video corresponding to the second viewpoint specified by the specification unit. Therefore, in a case where the input of the comment regarding the object in the moving image is accepted, the area of the object and the area for displaying the comment can be displayed so as not to overlap.

The specification unit specifies the second viewpoint on the basis of the area of the object included in the video being displayed corresponding to the first viewpoint and the area of the related information. The specification unit, in a case where the area of the object included in the video being displayed corresponding to the first viewpoint and the area of the related information overlap, specifies the viewpoint in which the area of the object does not overlap the area of the related information as the second viewpoint. The specification unit, in a case where the predetermined partial area in the area of the object and the area of the related information overlap, specifies a viewpoint in which the partial area and the area of the related information do not overlap as the second viewpoint. Therefore, in a case where the area of the object and the area for displaying the comment result in being displayed overlapping, it is possible to specify the second viewpoint position and cause the video in which the area of the object and the area for displaying the comment do not overlap to be displayed.

The specification unit, in a case where the remaining area excluding the area of the object from the area of the video is smaller than the area for causing the related information to be displayed, specifies a viewpoint in which the remaining area is equal to or larger than the area for causing the related information to be displayed as the second viewpoint. Therefore, it is possible to easily determine whether or not the area of the object and the area for the comment overlap and display the area of the object and the area for displaying the comment so as not to overlap.

The specification unit specifies the viewpoint obtained by moving the first viewpoint in the direction away from the position of the object as the second viewpoint. The specification unit specifies the viewpoint obtained by rotating the first viewpoint around a predetermined position in the video corresponding to the first viewpoint as the second viewpoint. Therefore, it is possible to secure the area for displaying the comment that does not overlap the area of the object while leaving the object referenced by the user in the video.

The acquisition unit acquires the post information posted for the object included in the video as the related information. Therefore, it is possible to display the post information regarding the object without overlapping the target object.

In a case where the acquisition unit acquires a plurality of pieces of post information by a plurality of users, the display unit causes the post information to be displayed according to the priority based on the relationship between the plurality of users. Therefore, it is possible to display the post information according to the priority. For example, among the post information having a high priority and the post information having a low priority, it is possible to display the post information having a high priority.

As the related information, the acquisition unit acquires the post information posted for the content of the competition performed by the plurality of objects included in the video. Therefore, it is possible to display not only the post information corresponding to the object but also the post information regarding the content of the competition without overlapping the object.

The display unit causes the related information to be displayed so as to follow the object. Therefore, even in a case where the object related to the related information moves, it is possible to display the related information near the object always.

In a case where the number of characters included in the related information is equal to or more than a predetermined number of characters, the display unit causes the related information to be displayed in a predetermined display area. Therefore, it is possible to display the related information easily even in a case where the number of characters is large and it is difficult to secure the area for displaying the related information.

The display unit causes the free viewpoint video to be displayed on the basis of the first viewpoint and, in a case where the second viewpoint is specified, causes the free viewpoint video to be displayed on the basis of the second viewpoint. For example, the display unit causes the display device that displays the VR video to display the free viewpoint video and the related information. The display unit causes the display device that displays the AR video to display the related information. Therefore, even in a case where displaying the free viewpoint video such as VR and the like or where displaying the AR video, it is possible to display the area of the object and the area for displaying the comment so as not to overlap.

Note that the present technology may also be configured as below.

(1)

An information processing device including
an acquisition unit that acquires related information related to video,
a specification unit that, on the basis of the related information acquired by the acquisition unit and video corresponding to a first viewpoint, specifies a second viewpoint different from the first viewpoint, and
a display unit that, together with video corresponding to the second viewpoint specified by the specification unit, causes the related information acquired by the acquisition unit to be displayed.

(2)

The information processing device according to (1), in which
the specification unit specifies the second viewpoint on the basis of an area of an object included in video being displayed corresponding to the first viewpoint and an area of the related information.

(3)

The information processing device according to (1) or (2), in which
the specification unit, in a case where the area of the object included in the video being displayed corresponding to the first viewpoint and the area of the related information overlap, specifies a viewpoint in which the area of the object does not overlap the area of the related information as the second viewpoint.

(4)

The information processing device according to any one of (1) to (3), in which
the specification unit, in a case where a partial area being predetermined in the area of the object and the area of the related information overlap, specifies a viewpoint in which the partial area and the area of the related information do not overlap as the second viewpoint.

(5)

The information processing device according to any one of (1) to (4), in which
the specification unit, in a case where a remaining area excluding the area of the object from an area of the video is smaller than an area for causing the related information to be displayed, specifies a viewpoint in which the remaining area is equal to or larger than the area for causing the related information to be displayed as the second viewpoint.

(6)

The information processing device according to any one of (1) to (5), in which
the specification unit specifies a viewpoint obtained by moving the first viewpoint in a direction away from a position of the object as the second viewpoint.

(7)

The information processing device according to any one of (1) to (6), in which
the specification unit specifies a viewpoint obtained by rotating the first viewpoint around a predetermined position in the video corresponding to the first viewpoint as the second viewpoint.

(8)

The information processing device according to any one of (1) to (7), in which
the acquisition unit acquires post information posted for an object included in the video as the related information.

(9)

The information processing device according to any one of (1) to (8), in which
the display unit, in a case where the acquisition unit acquires a plurality of pieces of post information by a plurality of users, causes the post information to be displayed according to a priority based on a relationship between the plurality of users.

(10)

The information processing device according to any one of (1) to (9), in which

the acquisition unit, as the related information, acquires post information posted for a content of a competition performed by a plurality of objects included in the video.

(11)

The information processing device according to any one of (1) to (10), in which the display unit causes the related information to be displayed so as to follow the object.

(12)

The information processing device according to any one of (1) to (11), in which the display unit, in a case where a number of characters included in the related information is equal to or more than a predetermined number of characters, causes the related information to be displayed in a predetermined display area.

(13)

The information processing device according to any one of (1) to (12), in which the display unit causes free viewpoint video to be displayed on the basis of the first viewpoint and, in a case where the second viewpoint is specified, causes free viewpoint video to be displayed on the basis of the second viewpoint.

(14)

The information processing device according to any one of (1) to (13), in which the display unit causes a display device that displays virtual reality (VR) video to display the free viewpoint video and the related information.

(15)

The information processing device according to any one of (1) to (13), in which the display unit causes a display device that displays augmented reality (AR) video to display the related information.

(16)

An information processing method for executing processing by a computer, the processing including
acquiring related information related to video,
on the basis of the related information being acquired and video corresponding to a first viewpoint, specifying a second viewpoint different from the first viewpoint, and
together with video corresponding to the second viewpoint being specified, causing the related information acquired by the acquisition unit to be displayed.

(17)

An information processing program for causing a computer to function as
an acquisition unit that acquires related information related to video,
a specification unit that, on the basis of the related information acquired by the acquisition unit and video corresponding to a first viewpoint, specifies a second viewpoint different from the first viewpoint, and
a display unit that, together with video corresponding to the second viewpoint specified by the specification unit, causes the related information acquired by the acquisition unit to be displayed.

### REFERENCE SIGNS LIST

10, 60 HMD

60 Distribution server

70 Comment management server

100 Information processing device

105 Interface unit

110 Communication unit

120 Storage unit

121 Comment information

122 Comment table

123 Content table

124 Viewpoint information

125 Free viewpoint video information

130 Control unit

131 Acquisition unit

132 Comment information generation unit

133 Comment information transmission unit

134 Display unit

1. An information processing device comprising:
an acquisition unit that acquires related information related to video;
a specification unit that, on a basis of the related information acquired by the acquisition unit and video corresponding to a first viewpoint, specifies a second viewpoint different from the first viewpoint; and
a display unit that, together with video corresponding to the second viewpoint specified by the specification unit, causes the related information acquired by the acquisition unit to be displayed.

2. The information processing device according to claim 1, wherein
the specification unit specifies the second viewpoint on a basis of an area of an object included in video being displayed corresponding to the first viewpoint and an area of the related information.

3. The information processing device according to claim 2, wherein
the specification unit, in a case where the area of the object included in the video being displayed corresponding to the first viewpoint and the area of the related information overlap, specifies a viewpoint in which the area of the object does not overlap the area of the related information as the second viewpoint.

4. The information processing device according to claim 3, wherein
the specification unit, in a case where a partial area being predetermined in the area of the object and the area of the related information overlap, specifies a viewpoint in which the partial area and the area of the related information do not overlap as the second viewpoint.

5. The information processing device according to claim 2, wherein
the specification unit, in a case where a remaining area excluding the area of the object from an area of the video is smaller than an area for causing the related information to be displayed, specifies a viewpoint in which the remaining area is equal to or larger than the area for causing the related information to be displayed as the second viewpoint.

6. The information processing device according to claim 3, wherein
the specification unit specifies a viewpoint obtained by moving the first viewpoint in a direction away from a position of the object as the second viewpoint.

7. The information processing device according to claim 3, wherein
the specification unit specifies a viewpoint obtained by rotating the first viewpoint around a predetermined position in the video corresponding to the first viewpoint as the second viewpoint.

8. The information processing device according to claim 1, wherein
the acquisition unit acquires post information posted for an object included in the video as the related information.

9. The information processing device according to claim 8, wherein
the display unit, in a case where the acquisition unit acquires a plurality of pieces of post information by a plurality of users, causing the post information to be displayed according to a priority based on a relationship between the plurality of users.

10. The information processing device according to claim 9, wherein
the acquisition unit, as the related information, acquires post information posted for a content of a competition performed by a plurality of objects included in the video.

11. The information processing device according to claim 8, wherein the display unit causes the related information to be displayed so as to follow the object.

12. The information processing device according to claim 8, wherein the display unit, in a case where a number of characters included is the related information is equal to or more than a predetermined number of characters, causes the related information to be displayed in a predetermined display area.

13. The information processing device according to claim 1, wherein the display unit causes free viewpoint video to be displayed on a basis of the first viewpoint and, in a case where the second viewpoint is specified, causes free viewpoint video to be displayed on a basis of the second viewpoint.

14. The information processing device according to claim 13, wherein the display unit causes a display device that displays virtual reality (VR) video to display the free viewpoint video and the related information.

15. The information processing device according to claim 1, wherein the display unit causes a display device that displays augmented reality (AR) video to display the related information.

16. An information processing method for executing processing by a computer, the processing comprising:
acquiring related information related to video;
on a basis of the related information being acquired and video corresponding to a first viewpoint, specifying a second viewpoint different from the first viewpoint; and
together with video corresponding to the second viewpoint being specified, causing the related information acquired by the acquisition unit to be displayed.

17. An information processing program for causing a computer to function as:
an acquisition unit that acquires related information related to video;
a specification unit that, on a basis of the related information acquired by the acquisition unit and video corresponding to a first viewpoint, specifies a second viewpoint different from the first viewpoint; and
a display unit that, together with video corresponding to the second viewpoint specified by the specification unit, causes the related information acquired by the acquisition unit to be displayed.
